(19) United States
(12) Patent Application Publication
(10) Pub. No.: US 2026/0179380 A1
(43) Pub. Date: Jun. 25, 2026

(54) SYSTEM AND METHOD FOR AUTOMATIC RECOGNITION OF MEANINGFUL SHIFTS IN SCREEN RECORDING INTERACTIONS

(71) Applicant: NICE LTD., Ra'anana (IL)

(72) Inventors: Tal HAGUEL, Petach Tikva (IN); Neta ROSENFELD, Raanana (IL); Lior INTRATOR, Beer Yaakov (IL)

(73) Assignee: NICE LTD., Ra'anana (IL)

(21) Appl. No.: 18/999,743

(22) Filed: Dec. 23, 2024

(51) Int. Cl. G06V 20/40; G06V 10/74; G06V 10/774; G06V 10/776; G06V 10/82

(52) U.S. Cl. CPC G06V 20/44; G06V 10/761; G06V 10/774; G06V 10/776; G06V 10/82; G06V 20/46; G06V 20/48; G06V 2201/02

(57) ABSTRACT

In general, systems and methods are provided for training a neural network based on sample screen recordings wherein the neural network learns to minimize a reconstruction error between an original image input to the VAE, and an image reconstructed by the VAE. The systems and methods can provide determining and displaying significant points in time of the frame based on a similarity between compressed frames of a screen recording based on the trained VAE.

### TECHNICAL FIELD OF THE INVENTION

The present invention relates generally to automatic evaluation of video screen recordings. In particular, to identifying significant points in time in video screen recordings.

### BACKGROUND OF THE INVENTION

Currently, screen recordings can be taken of activity that occurs on a computer screen. For example, screen recordings of an agent's screen can be made of agent/customer interactions to evaluate performance of the agent. Current methods for analyzing screen recording typically involve an evaluator reviewing the screen recording videos and recording information related to noteworthy moments. Several difficulties can be present with the current approaches.

One difficulty can involve a volume of screen recordings (e.g., on the orders of thousands or tens of thousands) can be impossible for an evaluator to review (e.g., not enough time) such that random screen recordings or long recordings can be selected for evaluation. However, random screen recordings and/or long screen recordings may not accurately reflect a more common performance of the agent.

Each evaluator can evaluate the screen recording differently such that different evaluators may not obtain the same metrics and/or the same results for the same screen recording. This can lead to an unreliability and/or errors in results. Some screen recordings include several monitors and multiple applications between opened and switched between, which can further add to complexity and evaluation errors.

The current processes can be very slow and/or time consuming, contributing to lacking scalability and/or efficiency, and an inability to evaluate large volumes of interactions.

Therefore, it can be desirable to create an automated method for analyzing and determining significant shifts in screen recordings that can produce accurate and quick results.

### SUMMARY OF THE INVENTION

Advantages of the invention can include increase in accuracy, an ability to handle large volumes screen recordings, reliability and/or consistent metrics being captured for further analysis. Advantages of the invention can also include an ability to recommend relevant suggestions, for example, based on metrics.

In one aspect, the invention can involve a computerized-method for automatic recognition of significant points in time in screen recordings. The computerized-method can also involve receiving a video screen recording for analysis. The computerized-method can also involve compressing a plurality of frames from the video screen recording using a trained encoder of a variational image auto encoder (VAE) such that each frame of the plurality of frames is compressed into a vector. The computerized-method can also involve determining similarity between all of the plurality of frames using the vector, comparing two at a time. The computerized-method can also involve for each similarity that is above a first threshold or below a second threshold, identifying the respective two frames as a significant point in time. The computerized-method can also involve storing only the plurality of frames that are significant points in times.

In some embodiments, the method also involves training the encoder of a variational image auto encoder (VAE) by encoding and reconstructing a plurality of frames from a plurality of historical video screen recordings until a reconstruction error between the plurality of frames and the reconstructed plurality of frames is below a desired threshold.

In some embodiments, training the encoder can further involve: i) selecting the plurality of frames from each of the plurality of historical video screen recordings based on frame size, duration of the historical video screen recording, or any combination thereof, ii) compressing, by an encoder of the VAE, the plurality of frames to determine a numerical representation of the plurality of frames that is latent space that is smaller in size then the plurality of frames, wherein the numerical values are a distribution that includes mean and/or variance, iii) reconstructing the plurality of images, by a decoder of the VAE, based on the latent space, iv) determining the reconstruction error by taking a difference between the plurality of frames and the reconstructed plurality of frames, and v) if the reconstruction error is greater than the desired threshold, then inputting the reconstructed plurality of frames back to the encoder and repeating steps i) to v) until the reconstruction error is below the desired threshold, otherwise, for a reconstruction error that is below the desired threshold allow inference by the encoder.

In some embodiments, the distribution is a gaussian distribution, uniform, or binomial. In some embodiments, the plurality of historical video screen recordings is from various agent interactions. In some embodiments, the plurality of historical video screen recordings are between 1 minute and 5 minutes long.

In some embodiments, determining a reconstruction error by taking a difference further involves for each reconstructed frame and its corresponding original frame averaging the pixel values and taking the difference between the averages.

In some embodiments, determining the similarity further involves obtaining a cosine similarity score. In some embodiments, the method further involves outputting a graphical user interface that presents a timeline and highlights the significant points in time. In some embodiments, the video screen recording is of an agent customer interaction and the significant points in time are recommended frames for review.

In some embodiments, the length of the vector is based on an input image resolution of the video screen recording, number of layers in the encoder of trained encoder, or any combination thereof.

In another aspect, the invention includes a non-transitory computer program product comprising instruction which, when the program is executed cause the computer to receive a video screen recording for analysis, compress a plurality of frames from the video screen recording using a trained encoder of a variational image auto encoder (VAE) such that each frame of the plurality of frames is compressed into a vector, determine similarity between all of the plurality of frames using the vector, comparing two at a time, for each similarity that is above a first threshold or below a second threshold, identify the respective two frames as a significant point in time, and store only the plurality of frames that are significant points in times.

In some embodiments, the non-transitory computer program product further causes the computer to training the encoder of a variational image auto encoder (VAE) by encoding and reconstructing a plurality of frames from a plurality of historical video screen recordings until a reconstruction error between the plurality of frames and the reconstructed plurality of frames is below a desired threshold.

In some embodiments, training the encoder further includes i) select the plurality of frames from each of the plurality of historical video screen recordings based on frame size, duration of the historical video screen recording, or any combination thereof, ii) compress, by an encoder of the VAE, the plurality of frames to determine a numerical representation of the plurality of frames that is latent space that is smaller in size then the plurality of frames, wherein the numerical values are a distribution that includes mean and/or variance, iii) reconstruct the plurality of images, by a decoder of the VAE, based on the latent space, iv) determine the reconstruction error by taking a difference between the plurality of frames and the reconstructed plurality of frames, and v) if the reconstruction error is greater than the desired threshold, then input the reconstructed plurality of frames back to the encoder and repeating steps i) to v) until the reconstruction error is below the desired threshold, otherwise, for a reconstruction error that is below the desired threshold allow inference by the encoder.

In some embodiments, the distribution is a gaussian distribution, uniform, or binomial. In some embodiments, the plurality of historical video screen recordings is from various agent interactions. In some embodiments, the plurality of historical video screen recordings are between 1 minute and 5 minutes long.

In some embodiments, determining a reconstruction error by taking a difference further includes for each reconstructed frame and its corresponding original frame average the pixel values and taking the difference between the averages.

In some embodiments, determining the similarity further comprises obtaining a cosine similarity score. In some embodiments, the non-transitory computer program product is further caused to output a graphical user interface that presents a timeline and highlights the significant points in time.

These, additional, and/or other aspects and/or advantages of the present invention may be set forth in the detailed description which follows; possibly inferable from the detailed description; and/or learnable by practice of the present invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device which may be used with embodiments of the present invention.

FIG. 2 is flowchart for automatic recognition of significant points in times in screen recordings, according to some embodiments of the invention.

FIGS. 3A, 3B and 3C shows a variational image auto encoder (VAE), according to some embodiments of the invention.

FIG. 4A is a plot of screen recording changes over sixty (60) seconds for a video screen recording, according to some embodiments of the invention.

FIG. 4B is a graph of cosine similarity scores over sixty (60) seconds for a video screen recording, according to some embodiments of the invention.

FIG. 5 shows an example of a user interface that is part of an application player for the video screen recordings, according to some embodiments of the invention.

FIG. 6 is a diagram of a system architecture for automatic recognition of significant points in times in screen recordings, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units may be at least partially implemented by a computer processor.

As used herein, “machine learning”, “machine learning algorithms”, “machine learning models”, “ML”, or similar, may refer to models built by algorithms in response to/based on input sample or training data. ML models may make predictions or decisions without being explicitly programmed to do so. ML models require training/learning based on the input data, which may take various forms.

ML models may, for example, include Large Language Models (LLM) such as Generative Pre-Trained Transformer (GPT), Bidirectional Encoder Representations from Transformers (BERT), Pathways Language Model (PaLM) and the like, (artificial) neural networks (NN), decision trees, regression analysis, Bayesian networks, Gaussian networks, genetic processes, etc. Additionally, or alternatively, ensemble learning methods may be used which may use multiple/modified learning algorithms, for example, to enhance performance. Ensemble methods, may, for example, include “Random forest” methods or “XGBoost” methods.

Neural networks (NN) (or connectionist systems) are computing systems inspired by biological computing systems but operating using manufactured digital computing technology. NNs are made up of computing units typically called neurons (which are artificial neurons or nodes, as opposed to biological neurons) communicating with each other via connections, links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning proceeds. The weight increases or decreases the strength of the signal at a connection. Typically, NN neurons or nodes are divided or arranged into layers, where different layers can perform different kinds of transformations on their inputs and can have different patterns of connections with other layers. NN systems can learn to perform tasks by considering example input data, generally without being programmed with any task-specific rules, being presented with the correct output for the data, and self-correcting, or learning.

Various types of NNs exist. For example, a convolutional neural network (CNN) can be a deep, feed-forward network, which includes one or more convolutional layers, fully connected layers, and/or pooling layers. CNNs are particularly useful for visual applications. Other NNs can include for example transformer NNs, useful for speech or natural language applications, and long short-term memory (LSTM) networks.

Typical NNs can require that nodes of one layer depend on the output of a previous layer as their inputs. Current systems typically proceed in a synchronous manner, first typically executing all (or substantially all) of the outputs of a prior layer to feed the outputs as inputs to the next layer. Each layer can be executed on a set of cores synchronously (or substantially synchronously), which can require a large amount of computational power, on the order of 10 s or even 100 s of Teraflops, or a large set of cores. On modern GPUs this can be done using 4,000-5,000 cores.

It will be understood that any subsequent reference to “machine learning”, “machine learning algorithms”, “machine learning models”, “ML”, or similar, may refer to any/all of the above ML examples, as well as any other ML models and methods as may be considered appropriate.

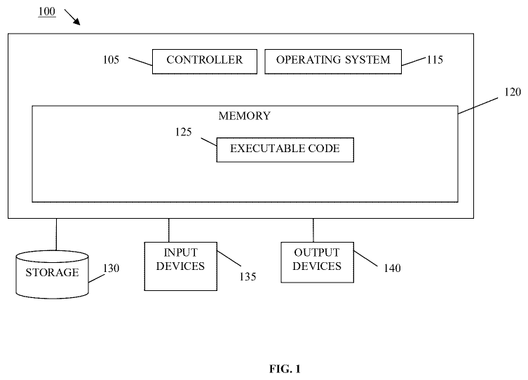

FIG. 1 shows a high-level block diagram of an exemplary computing device which may be used with embodiments of the present invention. Computing device 100 may include a controller or processor 105 that may be, for example, a central processing unit processor (CPU), a chip or any suitable computing or computational device, an operating system 115, a memory 120, a storage 130, input devices 135 and output devices 140 such as a computer display or monitor displaying for example a computer desktop system. Each of modules, methods and equipment and other devices and modules discussed herein, may be or include, or may be executed by, a computing device such as included in FIG. 1 although various units among these modules may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may store for example, instructions (e.g. code 125) to carry out a method as disclosed herein, and/or data.

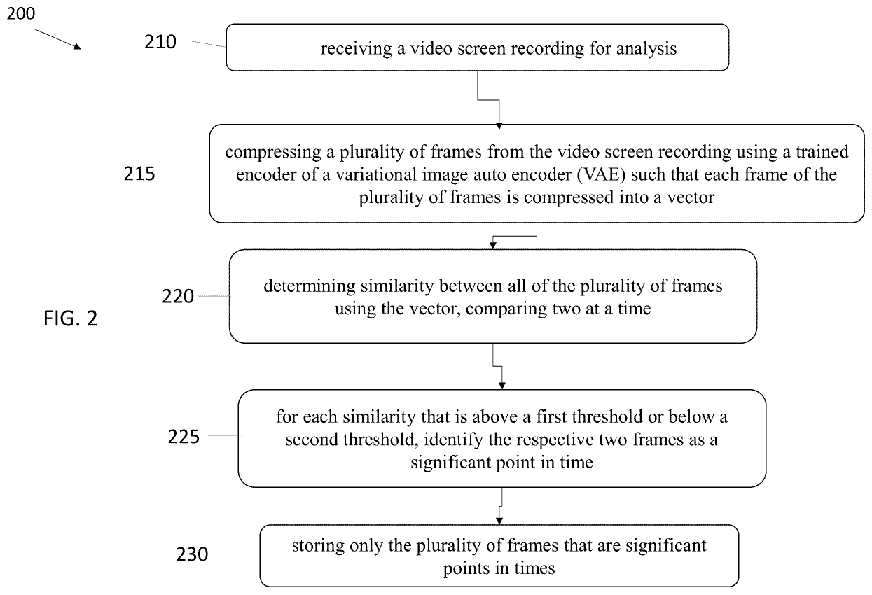

Executable code 125 may be any executable code, e.g., an application, a program, a process, task or script. Executable code 125 may be executed by controller 105 possibly under control of operating system 115. For example, executable code 125 may be one or more applications performing methods as disclosed herein, for example those of FIG. 2 or other figures, or other methods, according to embodiments of the present invention. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the present invention by, for example, executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data may be stored in a storage 130 and may be loaded from storage 130 into a memory 120 where it may be processed by controller 105. In some embodiments, some of the components shown in FIG. 1 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

In general, the invention can involve training a neural network (e.g., an encoder of a variational image auto encoder (VAE)) based on sample screen recordings wherein the neural network learns to minimize a reconstruction error between an original image input to the VAE, and an image reconstructed by the VAE. The invention can also involve determining significant points in time of the frame based on a similarity between compressed frames of a screen recording based on the trained VAE.

FIG. 2 is flowchart for automatic recognition of meaningful shifts (e.g., significant points in time) in screen recordings, according to some embodiments of the invention.

The method can involve receiving a video screen recording for analysis (Step 210). The received video screen recording can be a video screen recording for which analysis of meaningful shifts during the video screen recording is desired (e.g., video screen recording to occur in an inference phase with a trained model). The video screen recording can be of an agent/customer interaction. The video screen recording can be of one, two or any plurality of screens. The video screen recording can include frames where multiple applications were opened, used, and/or closed during the video screen recording. The video screen recording can be 2-7 minutes. The video screen recording can be any duration. The video screen recording can be in an MP4 format. In some embodiments, the video screen recording can be Avi, Gpeg or Wmi.

The method can involve compressing a plurality of frames from the video screen recording using a trained encoder of a variational image auto encoder (VAE) such that each frame of the plurality of frames is compressed into a vector (Step 215).

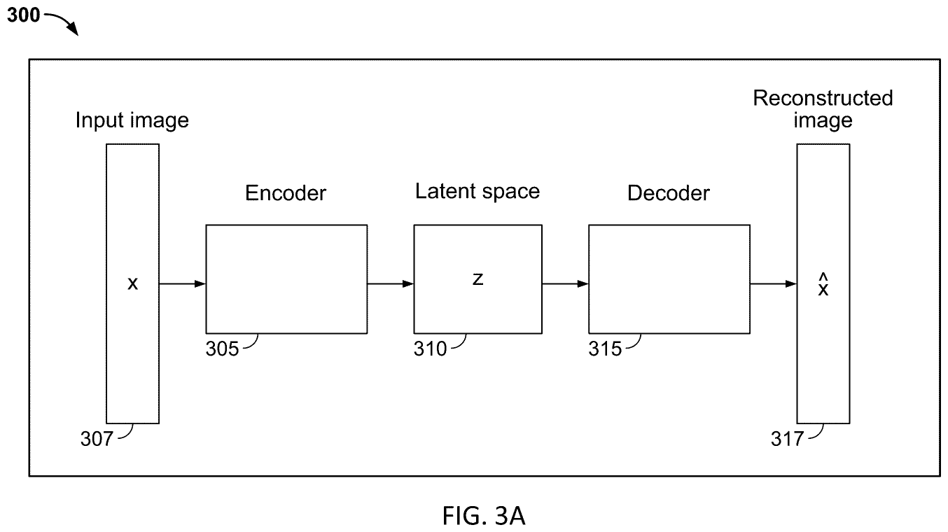

Turning to FIGS. 3A, 3B and 3C shows a VAE according to some embodiments of the invention.

The VAE 300 can include an encoder 305, latent space 310, and decoder 315. The encoder 305 can compress input data 307 (e.g., an image) into the latent space 310 representation. The encoder 305 can compress the input data by mapping it to a distribution (e.g., Gaussian). The encoder 305 can output parameters associated with the compression (e.g., for a Gaussian distribution a mean and variance). The latent space 310 can be where the compressed data is stored. The decoder 315 can receive as input samples from the latent space 310 and reconstruct the input data to obtain reconstructed data 317 (e.g., image). The reconstructed image 317 can be the same or similar to the input image 307.

The encoder of the VAE can be trained with a plurality of video screen recordings (e.g., on the order of hundreds or thousands). The plurality of video screen recordings can be historical agent/customer interactions. The plurality of historical video screen recordings can be between 1 minute and 5 minutes long. In some embodiments, the duration of the historical video screen recordings are any duration as captured by the respective system.

Each of the plurality of video screen recordings can be pre-processed by saving a screen shot (e.g., JPEG file) for each frame every one second of the respective video screen recording. Per video screen recording, each frame can be input to a VAE. The VAE can encode each of the frames into a numerical representation having a lower dimension then the dimension of the respective input frame (e.g., lower dimensional latent space). The lower dimension can be a vector of 256 dimensions. Per recording, each vector can be saved as a JavaScript Object Notation (JSON) file (or comma-separated values (CSV), or text (TXT)), that includes a frame index and the respective vector. For example, for a first video screen recording of the plurality of video screen recordings, a vector representation for a first frame can be fram_0=[−0, 2, 0, 1, 2, . . . , N], a vector representation for a second frame can be frame_1=[−0.5, 0.2, 1.6, . . . . N] where N is a number of values in the vector.

The length of the vectors can be based on a resolution of the respective input image (e.g., frame). The length of the vector can be based on input image resolution and/or number of layers in the neural network.

In various embodiments, the number of layers in the neural network varies based on image resolution.

In some embodiments, the length of the vectors output from the encoder can be as follows:

$$vector\_lenght = ( {x}^{*} y ) / ( {n}^{*} m ) \qquad EQN . 1$$

where x is a number of pixels on an x-axis of the input image, y is a number of pixels on the y axis, n is a first layer number of neurons in the neural network (e.g., 256), and m is a number of activation layers in the encoder.

For example, assume a VAE trained by High Definition (HD) images with 8 activation layers, and a first layer number of neurons can have a vector output from the encoder of =(1920*1080)/(256*8)=1012. In this manner, the length of the vector output from the encoder can be dynamic.

The vector values can be used to reconstruct the original frames. The difference between reconstructed frames and the originally input frames can be referred to as a reconstruction error. The reconstruction error can be determined by for each reconstructed frame and its corresponding original frame averaging the pixel values and taking the difference between the averages.

When the reconstruction error is below a threshold, it can be determined that the training is complete.

The layers of the VAE can be as shown in FIG. 3B and FIG. 3C, which can cause a minimization in the reconstruction error. The order of the layers in the VAE can reduce an image resolution in manner that allows for pixel quality to be maintained. The input data can be fed through the layers of the encoder 330 in the order as shown. The input data 330a can be fed into the layers as shown in FIG. 3A. Layers 330b, 330e, 330h, and 330k can be a two-dimensional convolutional layers (Conv2D), layers 330c, 330f, 330i, and 330l can be Rectified Linear Unit layers (ReLu), layers 330d, 330g, 330j, and 330m can be dropout layers, layer 330n can be a flatten layer, two layers 3300 and 330p can execute in parallel the output of the flatten layer 330n, and the layer 330q is a lambda layer. The output of the encoder 330 can be a float vector of dynamic length.

The output of the encoder 330 can be input to a decoder 340 having the layers as shown in FIG. 3C. The input data 340a can be fed through the layers of the decoder 340 in the order as shown. Layer 340b can be a dense layer, layer 340c can be a ReShape layer, layers 340d, 340g, 340j, and 340m can be a transposed convolution layer (e.g., deconvolution layer), layers 340e, 340h, 340k, and 340n can be Rectified Linear Unit layers (ReLu), layers 340f, 340i, 340l, and 340o, can be dropout layers, and layer 340q can be an activation layer. As described above, the output of the decoder 340 can be restoration data (e.g., restoration image). In this manner, the reconstruction error between the input 330a and the output of the decoder 340 can be minimized.

The number of layers in the encoder/decoder can vary based on image resolution. For example, for a neural network that was trained on data having a first resolution, if a video screen recording to be analyzed with the neural network has a second resolution, layers can be added/removed from the encoder/decoder to account for the resolution difference. In some embodiments, the layers can be added/removed by adding/removed a set of layers (e.g., for the encoder/decoder the Conv2D, ReLu, and Dropout). For example, assume the neural network was trained on a plurality of video recording having a first resolution that results in three (3) million pixels and a video screen recording to be analyzed with a second resolution that results in one (1) million pixels. In this example, in the encoder and decoder, the layers can be reduced by two sets of layers, the Conv2D, ReLu, and Dropout. For example, the encoder 330 and the decoder 340 can be reduced by removing Conv2D 330b, ReLU 330c, Dropout 330d, the Conv2D 330e, ReLu 330f, and Dropout 330g.

In some embodiments, if there is a difference between the resolution of the plurality of video screen recordings used to train the neural network and the resolution of the video screen recording to be analyzed in an inference, pixels can be added/removed from the video screen recording to be analyzed. For example, if the resolution of the video screen recording to be analyzed is less pixels then the training video screen recordings, additional pixels can be added (e.g., white pixels) to cause the video screen recording to be analyzed to have the same number of pixels as the training video screen recordings.

Turning back to FIG. 2, in some embodiments, an encoder of the VAE can be trained for each agent such that there is a unique model for each agent. In these embodiments, an agent for the received video screen recording can be determined, and a corresponding trained encoder can be used.

The method can involve determining similarity between all of the plurality of frames using the vector, comparing two at a time (Step 220). As described above, the encoder of the VAE can be trained. Using the trained encoder to obtain the vector output from Step 215, the similarity can be determined.

The similarity can be determined between each pair of consecutive vectors. For example, assume 100 frames that are encoded into 100 corresponding vectors. Vectors 1 and 2, 2 and 3, 3 and 4, and so forth can have similarity between them determined. The similarity can indicate a measure of degree of similarity between two vectors, where a value of 1 indicates a higher similarity and a value of 0 indicates low similarity. In some embodiments, 0 indicates a higher similarity, and 1 indicates low similarity. The similarity can be determined based on a cosine similarity as follows:

$$cosine similarity = {S}_{C} ( A , B ) := cos ( θ ) = \frac{A \cdot B}{‖ A ‖ ‖ B ‖} = \frac{{\sum }_{i = 1}^{n} {A}_{i} {B}_{i}}{\sqrt{{\sum }_{i = 1}^{n} {A}_{i}^{2} \cdot } \sqrt{{\sum }_{i = 1}^{n} {B}_{i}^{2}}} , \qquad EQN . 2$$

where A is a first vector, B is a second vector, and n is an integer representing the number of values in the vectors.

In some embodiments, similarity is based on a L2 Euclidean distance score.

The method can involve for each similarity that is above a first threshold or below a second threshold, identify the respective two frames as a significant point in time (Step 225). The first threshold can be a user input. The second threshold can be a user input. The first and/or second thresholds can be based on a total number of changed pixels vs. the entire image area.

The method can involve storing only the plurality of frames that are significant points in times (Step 230). A JSON file can be used per screen recording. The pairs of frames that caused a significant point in time can be stored in the JSON file along with their respective cosine similarity score and timestamp.

In some embodiments, recommendations and or metrics regarding the plurality of video screen recordings and/or regarding a single video screen recording based on the significant points in time can be output (e.g., on a display via a graphical user interface to a user or transmitted to another system).

In embodiments where a JSON file is used per screen recording to store the significant points in time, the JSON file data can be used to determine one or more metrics.

In some embodiments, a trend metric can be determined for each of the video screen recordings. The trend metric can be determined by counting how many unique cosine similarity values (e.g., different cosine similarity values) in total frames of the video screen recording. Recordings that have a number of unique cosine similarity values above a threshold, then this can indicate that the particular video screen recording needs to be investigated.

In some embodiments, a recording metric can be determined for each of the video screen recordings. The recording metric can be determined by calculating a percentage of cosine similarity values that had a highest and lowest changes over the screen recording time. For example, assume a total of four frames having cosine similarity values: between frame 1 and frame 2:0.8, between frame 2 and frame 3:0.4, and between frame 3 and frame 4:0.1. For a cosine similarity value between 1 and −1, closer to 1 is more similar and closer to −1 is less similar. In this example, the frames pairs with the lowest similarity scores are between frame 3 and frame 4, meaning this is where the highest change occurred. The frame number divided by the total duration of the video can result in determining the time period in the video screen recording that the highest change occurred. In this example, assume one (1) frame per second, this results in the highest change at 3-4 seconds.

In some embodiments, for each of the plurality of video screen recordings the trend metric, and recording metric (high and low), can be determined. Table 1 shows an example of a repository having metric determinations for two video screen recordings of agent/client interactions.

TABLE 1

| | | Recording | Recording | |
|---|---|---|---|---|
| | | metric - | metric - | |
| | Trend | Top x | Low x | |
| | metric | (unique | (unique | |
| Interactionid | (count- | count- | count- | Dictionary pair cosine |
| (integer) | integer) | integer) | integer) | similarity location |
| 1234 | 4 | 2 | 1 | \\storage\\1234_similarity.json |
| 122 | 6 | 5 | 5 | \\storage\\122_similarity.json |

Each of the video screen recordings includes a unique identifier of interaction id, the trend metric, recording metrics, high and low, and dictionary location, wherein the dictionary can include keys that are the frame id pairs and the values are the similarity score.

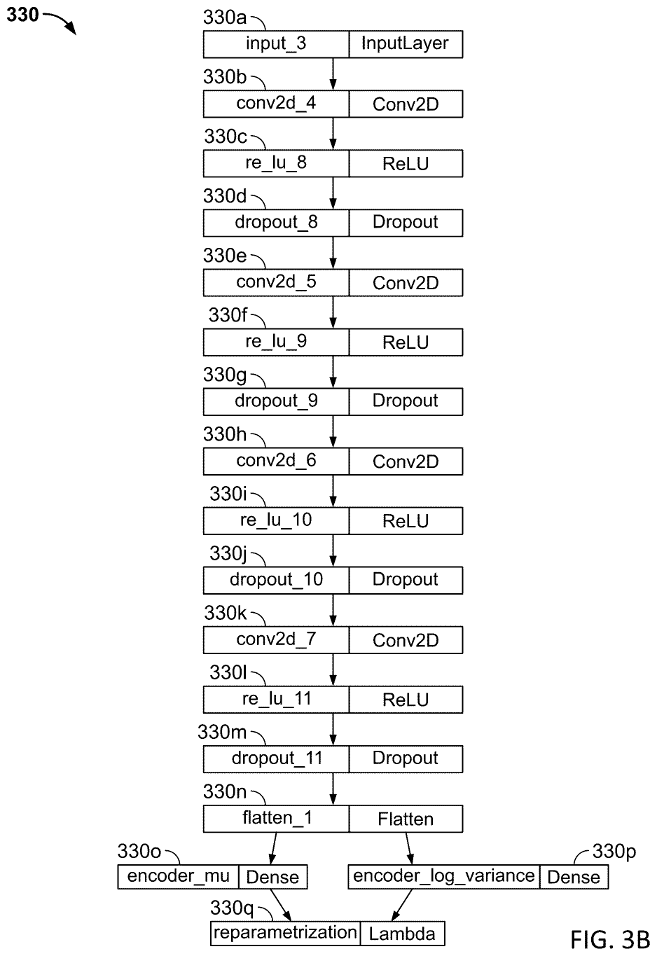

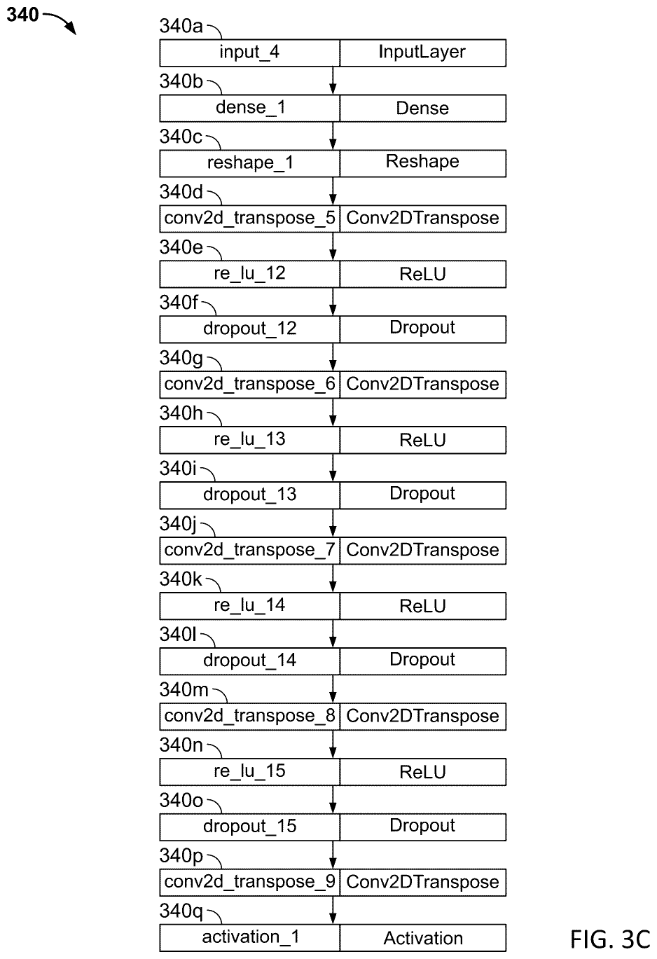

For example, turning to FIGS. 4A and 4B, FIG. 4A is a plot of screen recording changes over sixty (60) seconds for a video screen recording, according to some embodiments of the invention. FIG. 4B is a graph of cosine similarity scores over sixty (60) seconds for a video screen recording, according to some embodiments of the invention. With the highest and lowest values, it can be determining which times to recommend to review the recording and/or limit the available recording to these times.

In some embodiments, video screen recordings that have significant points in time can have an indicator at the significant point in time so that the significant points in time are indicated during playback. In some embodiments, only significant points in time can be available for playback. In some embodiments, the significant points in time can be added to its respective video screen recording by inserting a URL at the significant point in time.

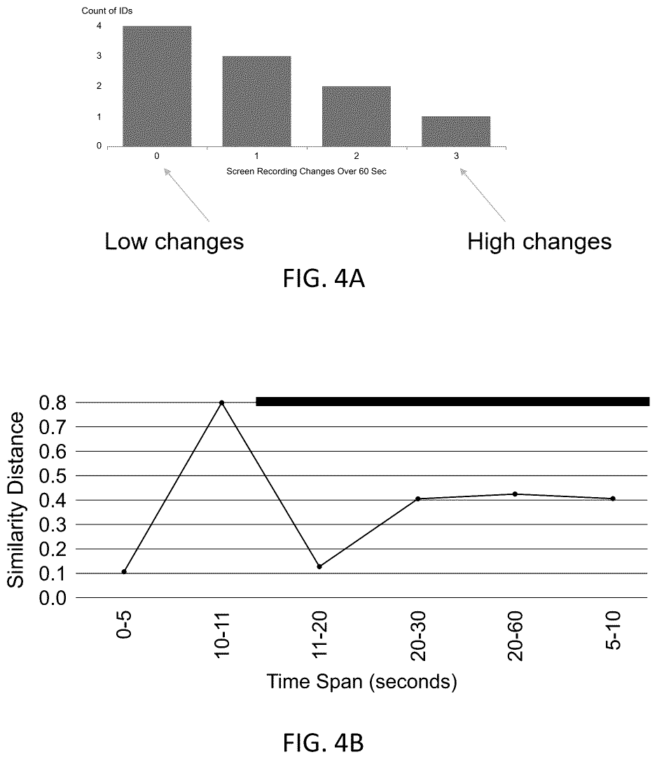

FIG. 5 shows an example of a user interface that is part of an application player for the video screen recordings, according to some embodiments of the invention. The markings on the timeline 510 can indicate the most significant changes.

In some embodiments, the method of FIG. 2 and/or the metric calculations can be executed when the screen recording is happening. In these embodiments, the significant points in time and/or metric calculations can be used by the computer to automatically decide which screen recordings to save. For a system that saves screen recordings of agent/customer interactions automatically and systematically determining which interactions to save, instead of saving all interactions can allow for better computing performance and/or less computing resources to be used. When reading the frames, for a system that only records the relevant frames, accessing the recorded interaction can take less time b/c there will be less stored frames. For a system with hundreds or thousands of agents performing tens of thousands of interactions, this can be a significant improvement to the functioning of the computer.

In some embodiments, the plurality of video screen recordings used for training and the video screen recording for inference can be in a medical context. For example, for a person having an Ultrasound/MRI/CT/XRAY or any medical imaging as is known in art for a particular condition, a comparison can be done for significant changes between scans.

In some embodiments, the plurality of video screen recordings used for training and the video screen recording for inference can be in an entertainment context. For example, using historical clips of movies a user liked/disliked, movies with similar significant point in time metrics can be selected. In some embodiments, the plurality of video screen recordings used for training and the video screen recording for inference can be in a heath care context. For example, medical image scans taken in two different time frames can be compared to understand the progress by comparing using similarities. Small changes, almost the same, high changes can be an indicator of further testing.

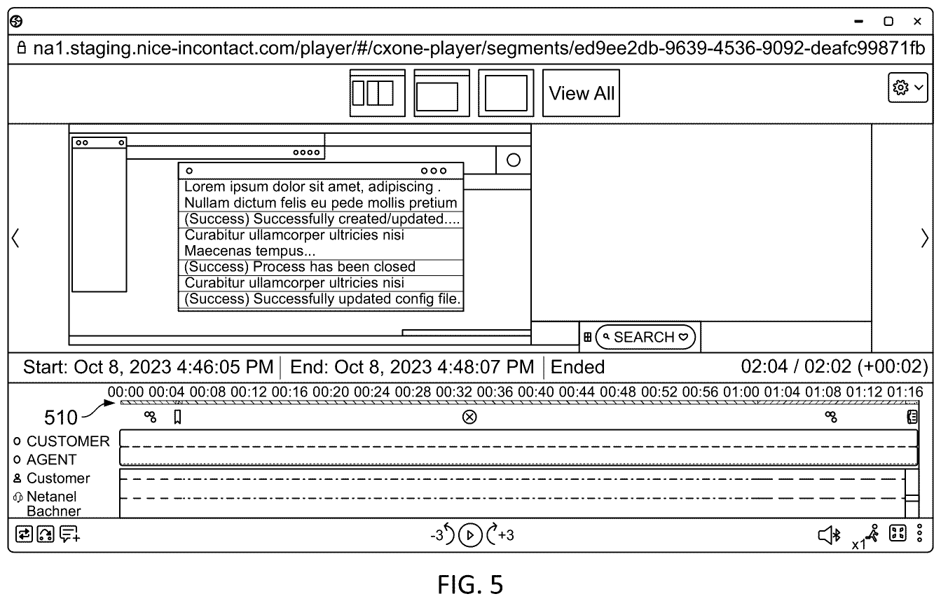

FIG. 6 is a diagram of a system architecture for automatic recognition of meaningful shifts (e.g., significant points in time) in screen recordings, according to some embodiments of the invention.

An evaluator 610 (e.g., a human or another computing system) transmits a request for video screen recording evaluation to an analytics server 615. The request can include a request to evaluate a particular agent, call center, or any combination. The analytics server 615 can include the code to execute the methods as described above. The analytics server 615 can present to the evaluator 610 one or a plurality of video screen recordings that have significant points in time. The analytics server 610 can communicate with a first database 620 of metadata associated with the video screen recordings (e.g., start time of a recording, end time of a recording, to which agent the recording belong to and/or saved location of the recording in storage) and/or a second database 625 of video screen recordings (e.g., captured during agent/customer interaction as described above) to retrieve the one or a plurality of video screen recordings relevant to the evaluator's request. The analytics server 610 can process the one or a plurality of video screen recordings in accordance with the methods above to provide the significant points in time to the evaluator 610, e.g., as described above through a GUI.

In embodiments where the video screen recordings are evaluated by the analytics server 615 prior to recording, the data in the first database 620 and the second database 625 can include JSON files and/or only video screen recordings that had significant points in time. As is apparent to one of ordinary skill in the art, the first and/or second database 620 and 625 can be in one database, and/or grouped with the analytics server 615.

The aforementioned flowcharts and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved, It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system or an apparatus. Accordingly, aspects of the present invention may take the form of an entirely hardware embodiment or an embodiment combining software and hardware aspects that may all generally be referred to herein as a “circuit,” “module” or “system.”

The aforementioned figures illustrate the architecture, functionality, and operation of possible implementations of systems and apparatus according to various embodiments of the present invention. Where referred to in the above description, an embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with materials equivalent or similar to those described herein.

While the invention has been described with respect to a limited number of embodiments, these should not be construed as limitations on the scope of the invention, but rather as exemplifications of some of the preferred embodiments. Other or equivalent variations, modifications, and applications are also within the scope of the invention. Accordingly, the scope of the invention should not be limited by what has thus far been described, but by the appended claims and their legal equivalents.

1. A computerized-method for automatic recognition of significant points in time in screen recordings, the method comprising:
receiving a video screen recording for analysis;
compressing a plurality of frames from the video screen recording using a trained encoder of a variational image auto encoder (VAE) such that each frame of the plurality of frames is compressed into a vector;
determining similarity between all of the plurality of frames using the vector, comparing two at a time;
for each similarity that is above a first threshold or below a second threshold, identifying the respective two frames as a significant point in time; and
storing only the plurality of frames that are significant points in times.

2. The computerized-method of claim 1 comprising training the encoder of a variational image auto encoder (VAE) by encoding and reconstructing a plurality of frames from a plurality of historical video screen recordings until a reconstruction error between the plurality of frames and the reconstructed plurality of frames is below a desired threshold.

3. The computerized-method of claim 2 wherein training the encoder further comprises:
i) selecting the plurality of frames from each of the plurality of historical video screen recordings based on frame size, duration of the historical video screen recording, or any combination thereof;
ii) compressing, by an encoder of the VAE, the plurality of frames to determine a numerical representation of the plurality of frames that is latent space that is smaller in size then the plurality of frames, wherein the numerical values are a distribution that includes mean and/or variance;
iii) reconstructing the plurality of images, by a decoder of the VAE, based on the latent space;
iv) determining the reconstruction error by taking a difference between the plurality of frames and the reconstructed plurality of frames; and
v) if the reconstruction error is greater than the desired threshold, then inputting the reconstructed plurality of frames back to the encoder and repeating steps i) to v) until the reconstruction error is below the desired threshold, otherwise, for a reconstruction error that is below the desired threshold allow inference by the encoder.

4. The computerized-method of claim 3 wherein the distribution is a gaussian distribution, uniform, or binomial.

5. The computerized-method of claim 2 wherein the plurality of historical video screen recordings is from various agent interactions.

6. The computerized-method of claim 2 wherein the plurality of historical video screen recordings are between 1 minute and 5 minutes long.

7. The computerized-method of claim 2 wherein determining a reconstruction error by taking a difference comprises:
for each reconstructed frame and its corresponding original frame averaging the pixel values and taking the difference between the averages.

8. The computerized-method of claim 1 wherein determining the similarity further comprises obtaining a cosine similarity score.

9. The computerized-method of claim 1 further comprising outputting a graphical user interface that presents a timeline and highlights the significant points in time.

10. The computerized-method of claim 9 wherein the video screen recording is of an agent customer interaction and the significant points in time are recommended frames for review.

11. The computerized-method of claim 1 wherein the length of the vector is based on an input image resolution of the video screen recording, number of layers in the encoder of trained encoder, or any combination thereof.

12. A non-transitory computer program product comprising instruction which, when the program is executed cause the computer to:
receive a video screen recording for analysis;
compress a plurality of frames from the video screen recording using a trained encoder of a variational image auto encoder (VAE) such that each frame of the plurality of frames is compressed into a vector;
determine similarity between all of the plurality of frames using the vector, comparing two at a time;
for each similarity that is above a first threshold or below a second threshold, identify the respective two frames as a significant point in time; and
store only the plurality of frames that are significant points in times.

13. The non-transitory computer program product of claim 12 wherein the non-transitory computer program product further causes the computer to training the encoder of a variational image auto encoder (VAE) by encoding and reconstructing a plurality of frames from a plurality of historical video screen recordings until a reconstruction error between the plurality of frames and the reconstructed plurality of frames is below a desired threshold.

14. The non-transitory computer program product of claim 13 wherein training the encoder further comprises:
vi) select the plurality of frames from each of the plurality of historical video screen recordings based on frame size, duration of the historical video screen recording, or any combination thereof;
vii) compress, by an encoder of the VAE, the plurality of frames to determine a numerical representation of the plurality of frames that is latent space that is smaller in size then the plurality of frames, wherein the numerical values are a distribution that includes mean and/or variance;
viii) reconstruct the plurality of images, by a decoder of the VAE, based on the latent space;
ix) determine the reconstruction error by taking a difference between the plurality of frames and the reconstructed plurality of frames; and
x) if the reconstruction error is greater than the desired threshold, then input the reconstructed plurality of frames back to the encoder and repeating steps i) to v) until the reconstruction error is below the desired threshold, otherwise, for a reconstruction error that is below the desired threshold allow inference by the encoder.

15. The non-transitory computer program product of claim 14 wherein the distribution is a gaussian distribution, uniform, or binomial.

16. The non-transitory computer program product of claim 13 wherein the plurality of historical video screen recordings is from various agent interactions.

17. The non-transitory computer program product of claim 13 wherein the plurality of historical video screen recordings are between 1 minute and 5 minutes long.

18. The non-transitory computer program product of claim 13 wherein determining a reconstruction error by taking a difference further comprises:
for each reconstructed frame and its corresponding original frame average the pixel values and taking the difference between the averages.

19. The non-transitory computer program product of claim 12 wherein the non-transitory computer program product further causes the computer to determine the similarity further comprises obtaining a cosine similarity score.

20. The non-transitory computer program product of claim 12 wherein the non-transitory computer program product further causes the computer to output a graphical user interface that presents a timeline and highlights the significant points in time.
